(19) United States
(12) Patent Application Publication
(10) Pub. No.: US 2004/0238699 A1
(43) Pub. Date: Dec. 2, 2004

(54) Kneeler

(76) Inventor: Richard A. Harp, Cleburne, TX (US)

Correspondence Address: Stephen R. Greiner, Esquire, GREINER LAW OFFICES, P.C., Suite 110, 6701 Democracy Blvd., Bethesda, MD, 20817, US

(21) Appl. No.: 10/448,371

(22) Filed: May 30, 2003

(51) Int. Cl. B68G 5/00

(52) U.S. Cl. 248/118

(57) ABSTRACT

A kneeler including a base plate having a lower surface with upwardly sloping side and rear edges permitting the kneeler to be rocked on a work surface to free such if stuck. A nose plate is joined at a shallow angle to, and extends upwardly from, the base plate remote from the side and rear edges.

### FIELD OF THE INVENTION

The present invention relates generally to rests for knees, legs and feet.

### BACKGROUND OF THE INVENTION

Laborers often kneel when finishing concrete by hand. Since kneeling directly upon an uncured slab leaves marks, it has become the practice in the industry to position small plywood sheets between a laborer's knees and a just-poured slab to distribute loads and minimize marking. Unfortunately, these sheets are hard to lift, tend to stick to wet concrete, and lack handles to get them unstuck. Furthermore, in obtaining a grasp on such sheets, concrete is often marked or marred requiring that additional time be spent to refinish the area.

### SUMMARY OF THE INVENTION

In light of the problems associated with the conventional means for supporting a concrete finisher on a slab, it is a principal object of the invention to provide a kneeler that distributes loads to prevent the knees of a concrete finisher from sinking into an uncured slab and is easily lifted from the uncured slab without marring it.

It is another object of the invention to provide a kneeler of the type described that is portable and has an integral handle so that the kneeler can be easily transported from place to place.

It is a further object of the invention to provide a kneeler that is comfortable and easy on the knees of a user thereby permitting a user to work longer in a kneeling position.

It is an additional object of the invention to provide a kneeler that is intuitive to use, requiring minimal instruction. The kneeler requires no specialized knowledge or tools to deploy. The kneeler can be used by: concrete finishers, gardeners, electricians, and anyone else who has to complete a task on his knees

It is an object of the invention to provide improved elements and arrangements thereof in a kneeler for the purposes described which is lightweight in construction, inexpensive to manufacture, and dependable in use.

Briefly, the kneeler in accordance with this invention achieves the intended objects by featuring a base plate having a lower surface with upwardly sloping side and rear edges. The base plate also has an upper surface with a recess. A nose plate is angularly joined to, and extends upwardly from, the base plate. A pad is secured within the recess by means of hook and loop fasteners.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a top view of a kneeler in accordance with the present invention.

FIG. 2 is a cross-sectional view of the kneeler taken along line 2-2 of FIG. 1.

FIG. 3 is an exploded cross-sectional view of the kneeler taken along line 3-3 of FIG. 1.

FIG. 4 is an environmental, perspective view of the kneeler.

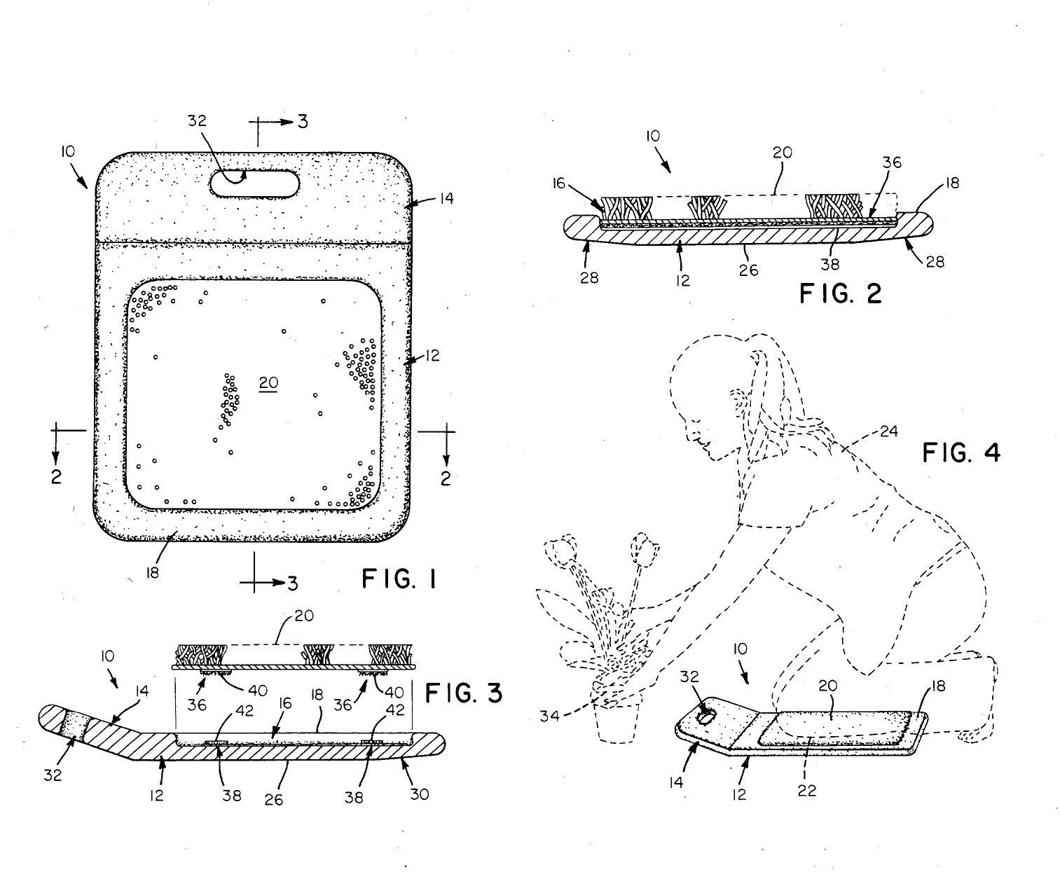

Similar reference characters denote corresponding features consistently throughout the accompanying drawings.

### DETAILED DESCRIPTION OF THE PREFERRED EMBODIMENT

Referring now to the FIGS., a kneeler in accordance with the present invention is shown at 10. Kneeler 10 includes a base plate 12 for positioning upon a work surface and a nose plate 14 joined at a shallow angle to the front end of base plate 12. Base plate 12 has a recess 16 in its upper surface 18 receiving a pad 20 for cushioning the knees 22 of a user 24 resting on kneeler 10. The lower surface 26 of base plate 12 is provided with upwardly sloping side and rear edges 28 and 30 permitting kneeler 10 to be rocked on a work surface to free it if stuck. Nose plate 14 has a slot 32 that permits kneeler 10 to be carried by the fingers 34 of user 24.

Pad 20, comprising a thick piece of carpet, is releasably secured to base plate 12 so that such can be replaced when wet, dirty or worn. To accomplish this, hook and loop fasteners 36 and 38 are affixed to pad 20 and base plate 12. Fastener 36 comprises a strip of “Velcro” pile material including a dense mat of small, uncut loops 40 formed of thread. Fastener 38, however, comprises a strip of “Velcro” hook material having a plurality of transverse lines of hooks 42 spaced along its length. The ends of hooks 42 are turned inwardly so as to catch in loops 40 when fasteners 36 and 38 are pressed together.

Use of kneeler 10 is straightforward. First, base plate 12 is positioned atop surface like an uncured concrete slab. Then, work atop the surface is performed in the usual manner, but in complete comfort as pad 20 cushions the knees. Next, if kneeler 10 needs to be moved over the work surface, the fingers 34 of user 24 are inserted into slot 32 in nose plate 14 and kneeler 10 is pushed or carried to the desired location. If it is found that kneeler 10, is stuck to the work surface, the application of a light downward force to the sides or rear of base plate 12 will cause kneeler 10 to rock onto one of edges 28 or 30 and permit kneeler 10 to be easily lifted. After use, kneeler 10 can be rinsed of concrete or dirt with a hose and, then, stored or transported in a relatively compact, ready-to-use condition.

Should pad 20 become wet, soiled, or worn, it can be easily removed from the remainder of kneeler 10 and replaced. To accomplish this, pad 20 is grasped at one of its corners and pulled away from base plate 12. Continued pulling will cause hooks 42 and loops 40 to disengage. The transverse line of disengagement will progress lengthwise of the interlocked fasteners 36 and 38 so that they will separate smoothly. A soiled pad 20 can be easily washed in soap and water and reinstalled when dry.

While the invention has been described with a high degree of particularity, it will be appreciated by those skilled in the art that modifications may be made thereto. For example, hook and loop fasteners 36 and 38 could be replaced by adhesive patches on pad 20 that are exposed by removal of a release liner. Such adhesive patches are not easily reused, however. Therefore, it is to be understood that the present invention is not limited to the sole embodiment described above, but encompasses any and all embodiments within the scope of the following claims.

I claim:

1. A kneeler, comprising:
a base plate having a lower surface with upwardly sloping side and rear edges permitting said kneeler to be rocked on a work surface to free such if stuck; and,
a nose plate angularly joined to, and extending upwardly from, said base plate remote from said side and rear edges.

2. A kneeler, comprising:
a base plate having a lower surface with upwardly sloping side and rear edges permitting said kneeler to be rocked on a work surface to free such if stuck, said base plate also having an upper surface with a recess therein;
a nose plate joined at a shallow angle to, and extending upwardly from, said base plate remote from said side and rear edges; and,
a pad secured to said base plate and positioned within said recess.

3. A kneeler, comprising:
a base plate having a lower surface with upwardly sloping side and rear edges, said base plate also having an upper surface with a recess therein;
a nose plate angularly joined to, and extending upwardly from, said base plate remote from said side and rear edges;
a pad positioned within said recess atop said base plate; and,
hook and loop fastening means for releasably attaching said pad to said base plate.
